(19) United States
(12) Patent Application Publication
(10) Pub. No.: US 2011/0022613 A1
(43) Pub. Date: Jan. 27, 2011

(54) Method and System for Qualifying CAD Objects

(75) Inventor: Thilo Stolper, Nurnberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, München (DE)

(21) Appl. No.: 12/865,626

(22) PCT Filed: Jan. 31, 2008
(86) PCT No.: PCT/EP08/00784

§ 371 Date: Jul. 30, 2010

(51) Int. Cl. G06F 17/30

(52) U.S. Cl. 707/756; 707/E17.044

(57) ABSTRACT

A method and a system for automatically qualifying CAD objects in two different CAx systems, wherein the CAD objects each model components of a physical system. In order to automatically qualify CAD objects in the CAx systems, which describe the same system components, with the same data records, a universal mapping rule is initially determined using system components that are qualified with data records in both CAx systems. The mapping rule is then applied to CAD objects that are qualified with a data records only in one CAx system to respectively identify a CAD object in the other CAx system, where the CAD object represents the same system component and is therefore supposed to be qualified with the same data record.

### CROSS-REFERENCE TO RELATED APPLICATIONS

This is a U.S. national stage of International Application No. PCT/EP2008/000784, filed on 31 Jan. 2008.

### BACKGROUND OF THE INVENTION

### FIELD OF THE INVENTION

The invention relates to a method and a CAx system for automatically identifying a Computer Aided Design (CAD) object which is assigned to a component that is already represented in another CAx system by a further CAD object and which is already assigned a data record in this other CAx system. The abbreviation CAx stands for all conventional “Computer Aided” systems. The “x” therefore represents a placeholder. The abovementioned CAx systems comprise CAD or Computer Aided Engineering (CAE) systems. The abbreviation CAD stands as usual for “Computer Aided Design” and CAD systems therefore refer to graphically oriented computer programs, which can be used to produce two or three-dimensional layouts. The term CAE stands for “Computer Aided Engineering” and should be seen as similar to Computer Aided Design, which is part of CAE. In addition to modeling and design, CAE also includes advanced analyses, simulations of a large number of physical events or optimization tools. The term “qualification” here and in the document as a whole refers quite generally to the assignment of a data record to a CAD object within a CAx system.

The use of CAD, CAE or CAM (Computer Aided Manufacturing) programs is widespread particularly in the field of digital product and factory planning. During planning, manufacture and up to and including any maintenance measures efforts are made to furnish data for the life cycle of a product over its entire life cycle. The aim here is to achieve an integral approach, in which efforts are made to manage data in the most uniform manner possible for the planning, implementation, control and ongoing improvement of all essential factory processes and resources relating to the product.

However, in digital product or production planning different CAx development environments are frequently used, in which the same real, physical components are modeled. Thus, for example, an industrial automation system with its components can, on the one hand, be modeled in a CAD system for planning the mechanical layout. The same system is, however, sometimes also simulated in a further CAD system by a corresponding CAD object, which is used for planning the electrical and electronic systems of the automation system, i.e., an Electronic Computer Aided Design (ECAD) system. In both CAD systems, the automation components of the automation system are represented by CAD objects. Similarly, it is possible for the same physical system with its components to be modeled in two different CAD development environments which are provided for the same discipline but originate from different producers or different versions. Such a situation could occur, for example, if CAD software used in a company is changed and data of significance for planning is still stored in the old system.

For purposes of uniform data management, i.e., in relation to a digital factory, it is desirable for CAD objects of different CAx systems, which describe the same real component, to access the same data records. Here, links required for this purpose between the CAD objects and the respectively shared data records can be set up manually by a user. However, setting up links in this manner is very time consuming.

### SUMMARY OF THE INVENTION

It is therefore an object of the invention to provide a method for setting up a shared database for a user of a number of CAx systems describing the same system components.

This and other objects and advantages are achieved in accordance with the invention by a method for automatically identifying a first CAD object within a first n-dimensional CAx system and for automatically assigning a data record to the identified first CAD object, where the first CAD object represents a component that is already represented in a second, m-dimensional CAx system by a second CAD object and which is already assigned the data record within the second CAx system. In accordance with the invention, the method comprises determining m further components, where each m further components is assigned a further first CAD object in the first CAx system with a further data record and a further second CAD object in the second CAx system with the same further data record defining a universal unambiguous mapping rule, which for each of the m further components, maps a point of the further second CAD object onto a point of an associated first further CAD object, applying the unambiguous mapping rule to a second point of the second CAD object to define a first point and to identify a target object having the first point as the first CAD object and assigning the data record to the first CAD object.

The object is also achieved by a system for automatically identifying a first CAD object within a first m-dimensional CAx system and for automatically assigning a data record to the identified first CAD object, where the first CAD object represents a component that is already represented in a second, m-dimensional CAx system by a second CAD object and which is already assigned the data record within the second system. The system includes a first device for determining m further components, where each of the m further components is assigned a further first CAD object in the first CAx system with a further data record and a further second CAD object in the second CAx system with the same further data record, a second device for defining a universal unambiguous mapping rule, which for each of the m further components, maps a point of the further second CAD object onto a point of the associated first further CAD object, a third device for applying the mapping rule to a second point of the second CAD object to define a first point and to identify a target object having the first point as the first CAD object and a fourth device for assigning the data record to the first CAD object.

In an embodiment, the system comprises a system component of a software development environment for digital factory planning, i.e., a CAE system component.

In accordance with the invention, two, i.e., CAD or CAE systems, each modulate the same components by CAD objects that are already qualified in the second CAx system with data records, which should be considered as the database for the purely graphic objects. In the simplest instance, such a data record is simply a designation by which a CAD object is assigned to a real component.

In contrast, the set of CAD objects stored in the first CAx system is not fully qualified. Only m components of the system to be modulated must be qualified with a corresponding data record in both CAx systems to automate qualification of the remaining components in the first CAx system that are not yet assigned to a data record. Here, m denotes the number of degrees of freedom that can be modeled by the second CAx system, i.e., generally two or three. If the second CAx system is a three-dimensional CAE or CAD modeling tool, for example, it is sufficient for three components to be qualified with a data record in both the first and second CAx systems.

A CAD object of the second CAx system, which describes the same component as a CAD object of the first CAx system and to which the same data record is therefore assigned, can be projected with the aid of linear mapping onto the corresponding CAD object in the first CAx system. In the case of a three-dimensional second CAx system linear mapping, which for each of the three further components, maps a point of a CAD object in the second CAx system onto a point of the CAD object in the first CAx system, which describes the same component, can be understood to be generally valid. That is, this mapping rule can now also be applied to the CAD objects, to which a data record is only assigned in the second CAx system but not yet in the first CAx system. If this mapping rule is now applied to a point of a CAD object in the second CAx system, to which no data record is yet assigned in the first CAx system, the mapping rule produces a point of a CAD object in the first CAx system that necessarily describes the same component. The target object is thus identified and the data record of the underlying CAD object in the second CAx system can also be automatically assigned to the CAD object.

The number of components that must be used to define a general mapping rule is a function of the dimension of the CAD system in which all the CAD objects are qualified. With a three-dimensional second CAx system at least three components have to be used, while with a two-dimensional system two components generally suffice.

In one advantageous embodiment of the invention, the first and second CAx systems comprise CAD systems. In these CAx systems, the CAD objects are defined directly by coordinates of a 2 or 3 dimensional coordinate system.

Alternatively, at least one of the CAx systems can also represent a CAE system, in which the CAD objects are imported, for example, from a CAD development environment to allow a simulation based on the imported objects. In another embodiment, the imported objects are positioned based on coordinates of a 2 or 3-dimensional space in the CAE system.

For an advantageous embodiment of the invention, the data record includes a designation used to address the second CAD object. The designation is particularly advantageous if, in a further embodiment of the invention, the first and second CAD objects are addressed using the designation by an engineering system of a higher order than the first and second CAx systems. This ensures that the same component can be addressed by the same designator independently of the system.

In a further advantageous embodiment of the invention, the data record is managed by a product management system. Such a product data management system ensures that the first and second CAD objects access the same database after qualification. Consequently, a change to the CAD object in the first CAx system impacts on the second CAD object in the second CAx, if this change is present in the data record assigned to the CAD objects. This embodiment avoids inconsistencies between the data of the CAD objects.

In a further advantageous embodiment, the data record contains configuration data for the first CAD object, where the configuration data is used for the automatic configuration of the first CAD object. It is thus possible to automate not only the identification of the first CAD object and the assignment of the data record but a subsequent configuration of the first CAD object is also performed automatically with the data which was also used to configure the first CAD object.

In a further advantageous embodiment, the dimensions of the CAx systems involved are identical, i.e., m=n=2 or m=n=3. Alternatively an embodiment of the invention may also be advantageous, in which m is not equal to n. For example, the same system with the same components can be modulated both by a three-dimensional CAD system for planning the mechanical layout and in a two-dimensional CAE system, which is used as a Graphical User Interface (GUI) for a simulation system for investigating regulation questions.

The CAD objects are modulated graphically within the systems by what are known as envelope geometries. In an advantageous embodiment, the points of the m further first and second CAD objects are respectively center points of envelope geometries associated with the further CAD objects. In particular, the mapping rule can be configured so that center points of the CAD objects of the first CAx system are mapped respectively onto center points of elements of the second CAx system and the center points of the second CAx system are mapped respectively onto elements of the first CAx system. In contrast an embodiment in which any points of the CAD objects of the first and second CAx systems are mapped onto one another is less demanding in respect of the mapping rule.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in more detail below based on the exemplary embodiments illustrated in the figures, in which:

FIG. 1 is an illustration of a qualification of a first CAD object in a first 3-dimensional CAx system with a data record, with which a second CAD object is already qualified in a second 3-dimensional CAx system;

FIG. 2 is an illustration of a qualification of a first CAD object in a first 3-dimensional CAx system with a data record, with which a second CAD object is already qualified in a second 2-dimensional CAx system;

FIG. 3 is an illustration of a qualification of a first CAD object in a first 2-dimensional CAx system with a data record, with which a second CAD object is already qualified in a second 3-dimensional CAx system; and

FIG. 4 is a flow chart of the method in accordance with an embodiment of the invention.

### DETAILED DESCRIPTION OF THE PREFERRED EMBODIMENTS

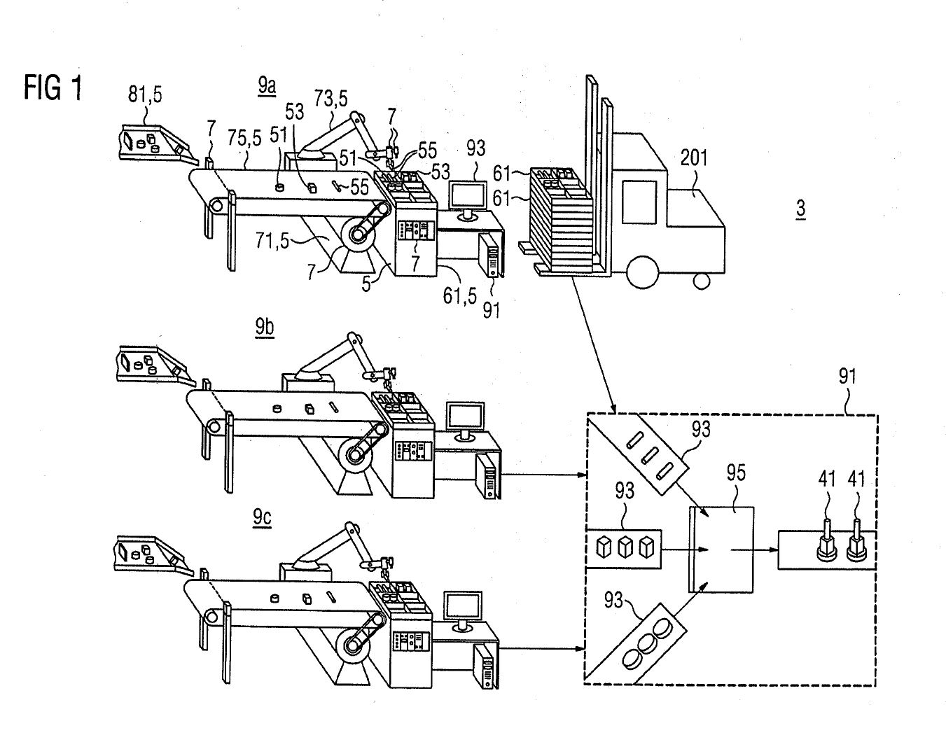

FIG. 1 is an illustration of a qualification of a first CAD object 11 in a first three-dimensional CAx system 10 with a data record 1, in which a second CAD object 21 is already qualified in a second three-dimensional CAx system 20. Here, the two CAx systems 10,20 comprise CAD systems. The first and second CAD systems 10,20 are used in the exemplary application illustrated for the digital planning of an industrial manufacturing system. FIG. 1 shows respective components of a conveyor system used to convey products to be manufactured in an automated manner. In both CAD systems 10,20 the components of the automation system are modeled by three-dimensional envelope geometries.

Even though the CAD models illustrated look identical at first glance, they represent different CAD systems with different tasks. Thus, in the first CAD system 10, the unit is modeled to visualize simulation results of a simulation of the automation process very clearly for a user. In contrast, the second CAD system 20 is used for mechanical layout planning for the automation system. Correspondingly, the second CAD system 20 contains a great deal more information than the first CAD system 10 for the individual system components to be modulated. The first CAD system 10 can access a pared-down variant of the data models used in the second CAD system 20.

A product data management system 5 is used for the purposes of uniform data management. The data management system 5 may comprise a personal computer, a laptop computer, a microprocessor, a programmable logic device, or an application specific integrated circuit, or any suitable device for performing computations in accordance with a computer program may be used. Within this product data management system 5, data records 1. . . 4 are managed, to which both CAD systems 10,20 have access. These data records 1,2,3,4 are assigned to the individual components of the automation system, i.e., resources. The CAD objects 21,22,23,24, created in the second CAD system 20 to modulate these resources, are already qualified with the corresponding data records 1,2,3,4. Within the first CAD system 10, however, a first CAD object 11 is not yet qualified with the corresponding data record 1. However, in the first CAD system 10 are three further components, which are modeled by further CAD objects 12,13,14, where these further first CAD objects 12,13,14 are already qualified with further data records 2,3,4. In sum, there are thus at least three components of the automation system, which are qualified in both CAD systems 10,20. These three components are sufficient to define a general transformation rule, which can be used to calculate the coordinates of a CAD object 11,12,13,14 for each CAD object 21,22,23,24 of the second CAD system 20 within the first CAD system 10, which describes the same component of the automation system. This transformation rule is a linear mapping, which follows the following relationship:

$$( \begin{matrix}{A}_{1} \\ {A}_{2} \\ {A}_{3}\end{matrix} ) = ( \begin{matrix}{x}_{11} & {x}_{12} & {x}_{13} \\ {x}_{21} & {x}_{22} & {x}_{23} \\ {x}_{31} & {x}_{32} & {x}_{33}\end{matrix} ) \cdot ( \begin{matrix}{B}_{1} \\ {B}_{2} \\ {B}_{3}\end{matrix} ) .$$

The coordinates A₁-A₃ here refer to a point of a CAD object 11,12,13,14 of the first CAD system 10 and the coordinates B₁-B₃ a point of a CAD object 21,22,23,24 within the second CAD system 20. It is now possible to define the mapping matrix X from the three known components, such as Drive _{—1,} Drive_{—2} and Drive_{—4.} To this end it is only necessary to resolve a corresponding equation system with known linear algebraic methods.

For the coordinates of the further components, which are already qualified at the start of the method in both CAD systems 10,20 it is possible, in each instance, to use the center points of the envelope curves associated with the CAD objects 12,13,14,22,23,24. If these points are used for each already qualified CAD object 12,13,14,22,23,24 when setting up the equation system to be resolved, a transformation matrix X results. The transformation matrix can be used to calculate center points of not yet qualified CAD objects 11 of the first CAD system 10 from the center points of the associated CAD objects 21 of the second CAD system 20. This calculation allows the CAD objects in the first CAD system 10 to be identified and then qualified.

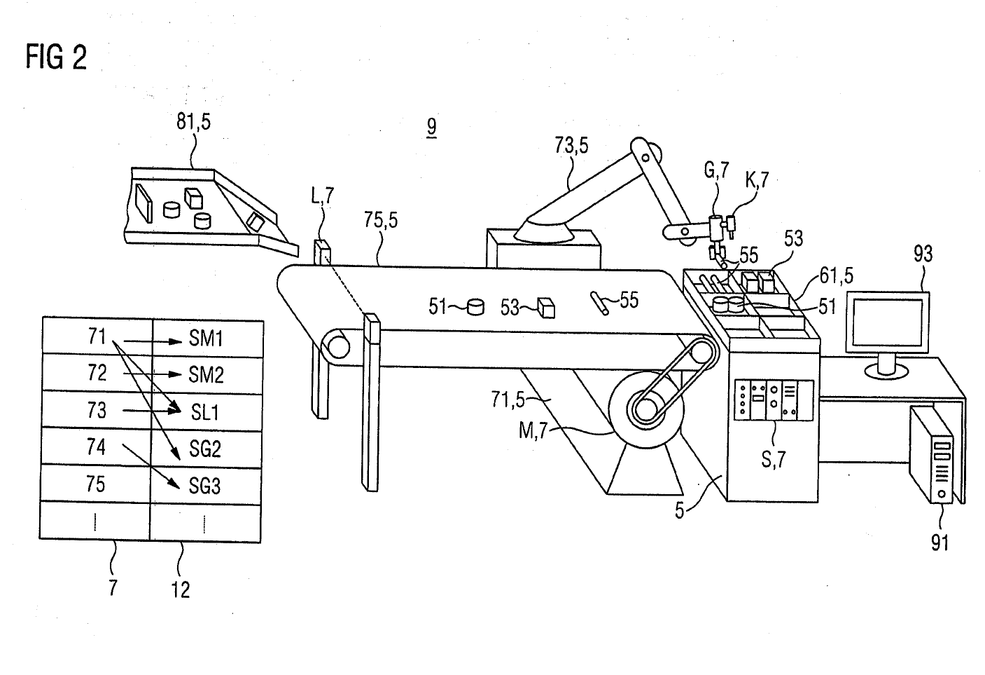

FIG. 2 is an illustration of a qualification of a first CAD object 11 in a first three-dimensional CAD system 10 with a data record 1, in which a second CAD object 21 is already qualified in a second two-dimensional CAD system 20. The two CAx systems 10,20 are CAD systems. In the example illustrated here the second CAD system 20, in which all the CAD objects 21-24 are already qualified with data records 1,2,3,4, is a two-dimensional CAD system, which is only provided for the schematic arrangement of the associated components, to design and simulate a regulation strategy. As in the instance in FIG. 1, it is also assumed here that a first CAD object 11 of the first CAD system 10 has not yet been qualified with the data record 1, with which a second CAD object 21 of the second CAD system 20 has already been qualified. In contrast, three further components are already qualified both in the first and also in the second CAD system 10,20 with the corresponding further data records 2,3,4.

Here too it is a matter first of defining a general mapping rule, which maps the points of CAD objects 21,22,23,24 of the second CAD system 20 onto points of CAD objects 11,12, 13,14 of the first CAD system 10, which describe the same components or are to be qualified with the same data records 1,2,3,4. The corresponding mapping rule follows the following relationship, where A₁-A₃ again describe the coordinates of a point in the first CAD system and B₁-B₂ represent coordinates of a point in the second CAD system 20:

$$( \begin{matrix}{A}_{1} \\ {A}_{2} \\ {A}_{3}\end{matrix} ) = ( \begin{matrix}{x}_{11} & {x}_{12} \\ {x}_{21} & {x}_{22} \\ {x}_{31} & {x}_{32}\end{matrix} ) \cdot ( \begin{matrix}{B}_{1} \\ {B}_{2}\end{matrix} ) .$$

To resolve this equation system, at least three further components are again required, which are qualified in both CAD systems 10,20. This gives six equations, which can be used to resolve the unknown x₁₁, x₁₂, x₂₁, x₂₂, x₃₁, x₃₂.

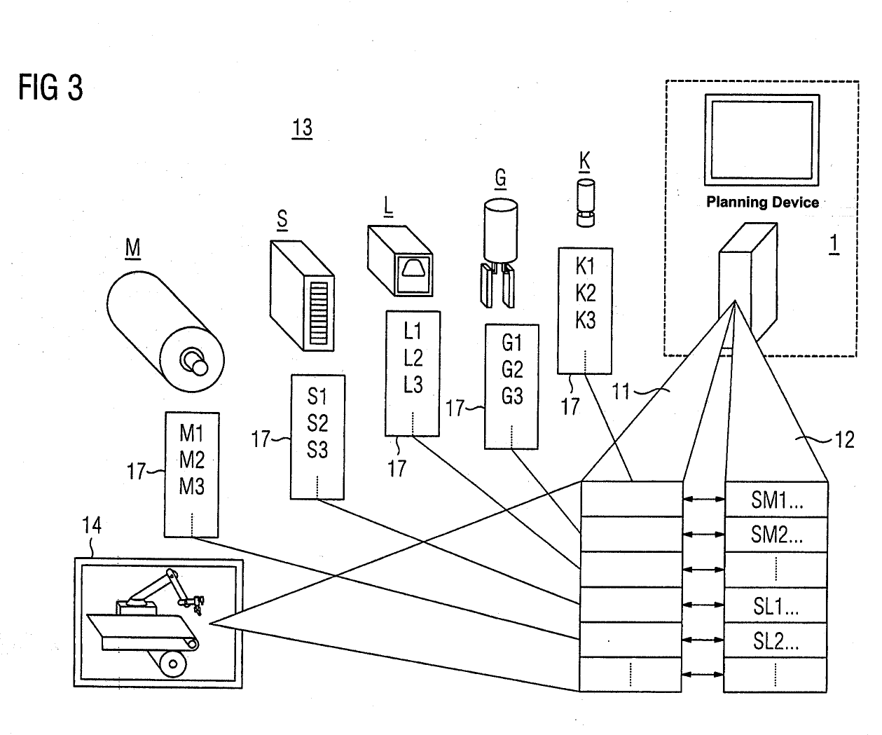

FIG. 3 is an illustration of a qualification of a first CAD object 11 in a first two-dimensional CAD system 10 with a data record 1, with which a second CAD object 21 is already qualified in a second three-dimensional CAD system 20. As before, two CAx systems 10,20 are CAD systems. The converse of the instance illustrated in FIG. 2 should be assumed here. In other words all the components of the automation system to be modulated are qualified in the three-dimensional second CAD system 20, while in the first CAD system 10 only two components of the automation system are already qualified. A general mapping rule can be given by the relationship below, where A₁-A₂ again describe the coordinates of a point in the first CAD system and B₁-B₃ represent for coordinates of a point in the second CAD system 20:

$$( \begin{matrix}{A}_{1} \\ {A}_{2}\end{matrix} ) = ( \begin{matrix}{x}_{11} & {x}_{12} & {x}_{13} \\ {x}_{21} & {x}_{22} & {x}_{23}\end{matrix} ) \cdot ( \begin{matrix}{B}_{1} \\ {B}_{2} \\ {B}_{3}\end{matrix} )$$

This mapping rule shows that only two components are required here, which are qualified in both CAD systems 10,20, to calculate the six unknown matrix components.

In summary, the disclosed embodiments of invention relate to a method and a system for automatically qualifying CAD objects in two different CAx systems, where the CAD objects model components of a physical system, respectively. To qualify CAD objects in the CAx systems, which describe the same system components, automatically with the same data records, a universal mapping rule is first defined based on system components, which are qualified with data records in both CAx systems. This mapping rule is then applied to CAD objects, which are only qualified with a data record in one CAx system to identify a CAD object respectively in the other CAx system, which represents the same system component and is therefore to be qualified with the same data record.

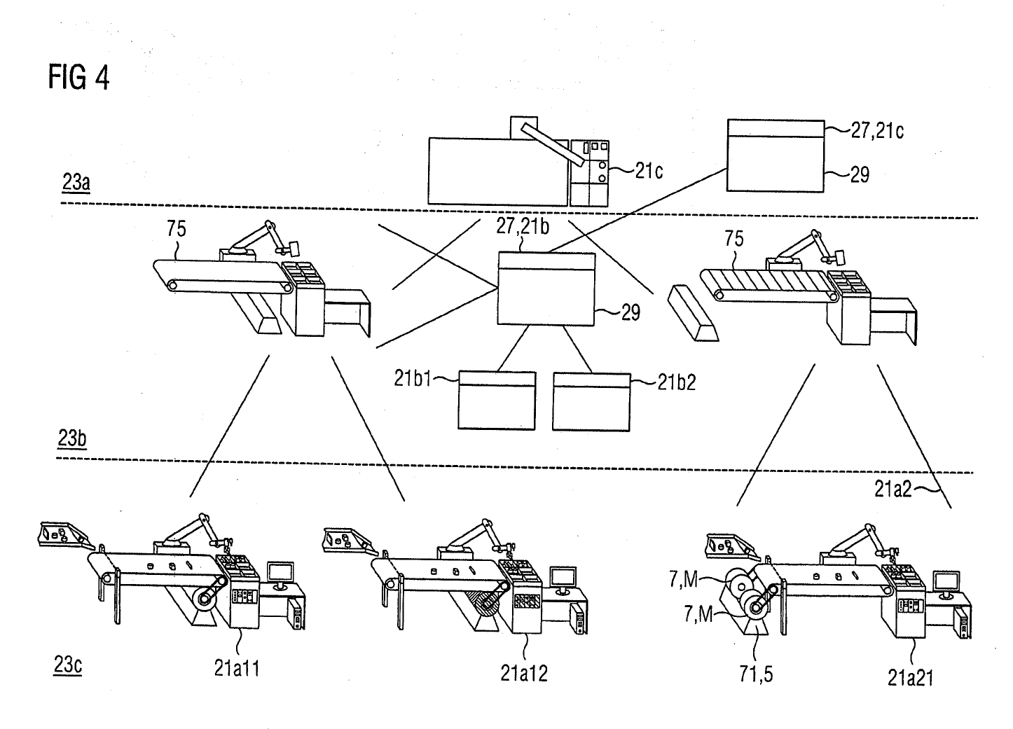

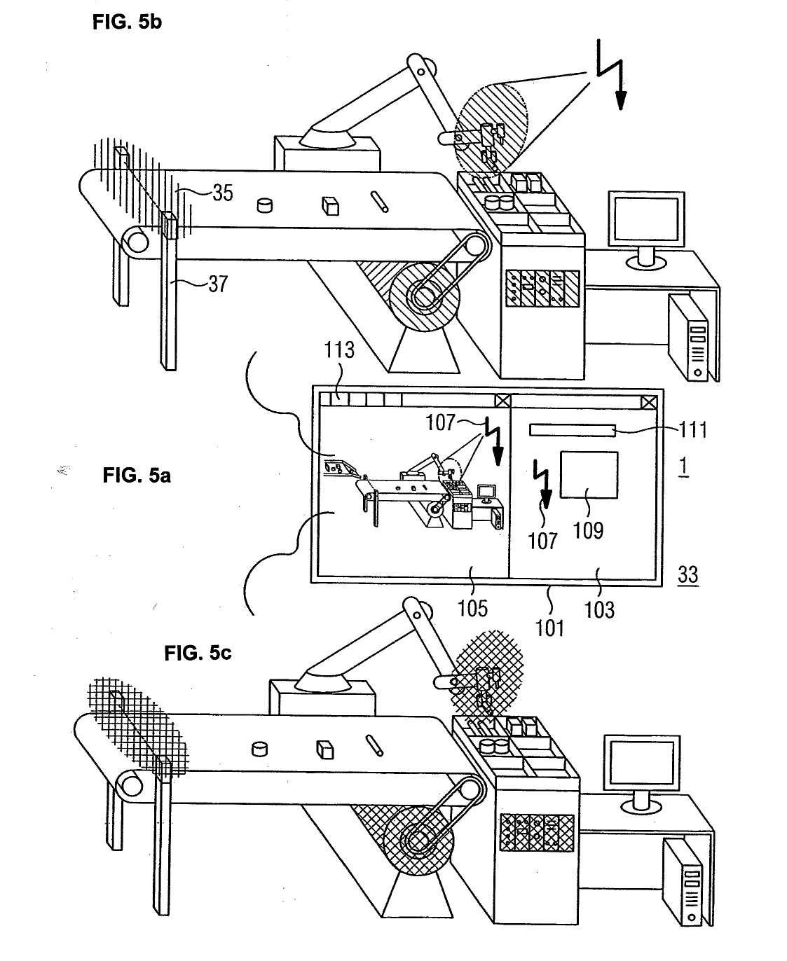

FIG. 4 is a flow chart illustrating a method for automatically identifying a first computer aided design object within a first n-dimensional computer aided (CAx) system and for automatically assigning a data record to the identified first CAD object, where the first CAD object represents a component which is already represented in a second, m-dimensional CAx system by a second CAD object and which is already assigned the data record within the second CAx system. The method comprises determining m further components, where each of the m further components is assigned a further first CAD object in the first CAx system with a further data record and a further second CAD object in the second CAx system with the same further data record, as indicated in step 410.

A universal unambiguous mapping rule is defined, as indicated in step 420. The universal unambiguous mapping rule maps a point of the further second CAD object onto a point of an associated first further CAD object for each of the m further components.

Next, the unambiguous mapping rule is applied to a second point of the second CAD object to define a first point and to identify a target object having the first point as the first CAD object, as indicated in step 430. The data record is then assigned to the first CAD object, as indicated in step 440.

Thus, while there have been shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. For example, it is expressly intended that all combinations of those elements and/or method steps which perform substantially the same function in substantially the same was to achieve the same results are within the scope of the invention. Moreover, it should be recognized that structures shown and/or elements and/or method steps shown and/or described in connection with any disclosed form or embodiment of the invention may be incorporated in any other disclosed or described or suggested form or embodiment as a general matter of design choice.

1.-20. (canceled)

21. A method for automatically identifying a first computer aided design (CAD) object within a first n-dimensional computer aided (CAx) system and for automatically assigning a data record to the first CAD object, the first CAD object representing a component which is already represented in a second, m-dimensional CAx system by a second CAD object and which is already assigned the data record within the second CAx system, the method comprising:
determining m further components, each of said m further components being assigned a further first CAD object in the first CAx system with a further data record and a further second CAD object in the second CAx system with the same further data record;
defining a universal unambiguous mapping rule, which for each of the m further components, maps a point of the further second CAD object onto a point of an associated first further CAD object;
applying the unambiguous mapping rule to a second point of the second CAD object to define a first point and to identify a target object having the first point as the first CAD object; and
assigning the data record to the first CAD object.

22. The method as claimed in claim 21, wherein the first and second CAx systems are CAD systems.

23. The method as claimed in claim 21, wherein at least one of the CAx systems is a computer aided engineering (CAE) system.

24. The method as claimed in claim 21, wherein the data record has a designation used to address the second CAD object.

25. The method as claimed in claim 21, wherein the first and second CAD objects are addressed in accordance with a designation by an engineering system of a higher order than the first and second CAx systems.

26. The method as claimed in claim 21, wherein the data record is managed by a product data management system.

27. The method as claimed in claim 21, wherein the data record contains configuration data for the first CAD object, said configuration data being used to automatically configure the first CAD object.

28. The method as claimed in claim 21, wherein m=n=2 or m=n=3.

29. The method as claimed in claim 21, wherein m and n are unequal.

30. The method as claimed in claim 21, wherein points of the m further first and second CAD objects are respectively center points of envelope geometries associated with the m further first and second CAD objects.

31. A system for automatically identifying a first computer aided design (CAD) object within a first n-dimensional computer aided (CAx) system and for automatically assigning a data record to the first CAD object, the first CAD object representing a component which is already represented in a second, m-dimensional CAx system by a second CAD object and which is already assigned the data record within the second CAx system, the system comprising:
means for determining m further components, each of said m further components being assigned a further first CAD object in the first CAx system with a further data record and a further second CAD object in the second CAx system with the same further data record;
means for defining a universal, unambiguous mapping rule, which for each of the m further components, maps a point of the further second CAD object onto a point of an associated first further CAD object;
means for applying the unambiguous mapping rule to a second point of the second CAD object to define a first point and to identify a target object having the first point as the first CAD object; and
means for assigning the data record to the first CAD object.

32. The system as claimed in claim 31, wherein the first and second systems are CAD systems.

33. The system as claimed in claim 31, wherein at least one of the CAx systems is a computer aided engineering (CAE) system.

34. The system as claimed claim 31, wherein the data record has a designation used to address the second CAD object.

35. The system as claimed in one of claim 31, wherein the system is comprises an engineering system of a higher order than the first and second CAx systems, said system being configured to address the first and second CAD objects in accordance with the designation.

36. The system as claimed in claim 31, wherein the CAx system comprises a product data management system configured to manage the data record.

37. The system as claimed in claim 31, wherein the data record contains configuration data for the first CAD object, the configuration data being provided to automatically configure the first CAD object.

38. The system as claimed in claim 31, wherein m=n=2 or m=n=3.

39. The system as claimed in claim 31, wherein m and n are unequal.

40. The system as claimed in claim 31, wherein points of the m further first and second CAD objects are respectively center points of envelope geometries associated with the m further first and second CAD objects.
